(19) United States
(12) Patent Application Publication
(10) Pub. No.: US 2012/0181114 A1
(43) Pub. Date: Jul. 19, 2012

(54) LUBRICANT DISTRIBUTOR AND LUBRICATING SYSTEM

(75) Inventors: Zdravko Paluncic, Ludwigshafen (DE); Andreas Schoenfeld, St. Leon-Rot (DE); Tobias Müller, Kraichtal (DE)

(73) Assignee: LINCOLN GMBH, Walldorf (DE)

(21) Appl. No.: 13/324,512

(22) Filed: Dec. 13, 2011

(30) Foreign Application Priority Data
Dec. 27, 2010 (DE) 202010016974.7

(51) Int. Cl. F16N 7/38; F01M 1/02; F16N 25/00

(52) U.S. Cl. 184/6.28; 184/6

(57) ABSTRACT

The invention pertains to a lubricant distributor for distributing lubricant to several lubricating points, with a cavity, in which a piston is arranged in a sealed and movable fashion. Several lubricant outlets, which are sealed relative to the cavity by the piston, lead into the cavity. The distributor has a lubricant inlet, from which at least one inlet channel leads into the cavity. A drive unit is provided for moving the piston in the cavity in a defined fashion. At least one channel is formed in the piston and makes it possible to produce a fluidic connection between the at least one inlet channel and one of the lubricant outlets depending on the position of the piston within the cavity. The invention furthermore pertains to a lubricating system that includes such a lubricant distributor and a lubricant pump that is connected to the lubricant inlet via a line.

### FIELD OF THE INVENTION

The invention pertains to a lubricant distributor for distributing a lubricant such as, e.g., grease to several lubricating points. The invention furthermore pertains to a lubricating system with such a lubricant distributor and a lubricant pump.

### BACKGROUND OF THE INVENTION

Various centralized lubricating systems such as, e.g., single line systems, dual line systems, multiple line systems and progressive systems are used for supplying lubricating points with lubricant. One common characteristic of all these lubricating systems is that the lubricating points receive the lubricant via corresponding distributors during a lubricating cycle. In this respect, lubricating points essentially can, if at all, only be supplied with arbitrarily varying quantities of lubricant within different time intervals, i.e., individually, with significantly higher expenditures. The lubricant quantities and the time intervals between two lubricating cycles are defined by the type of lubricating system and the distributor construction, respectively.

The present invention, in contrast, is based on the objective of developing a lubricant distributor and a lubricating system that make it possible to realize an individual lubricant supply of different lubricating points by means of a single lubricant pump, wherein the quantity of lubricant delivered to the respective lubricating point and the time intervals between two lubricating cycles can each be variably changed during the operation of the lubricant distributor.

### SUMMARY OF THE INVENTION

This objective is essentially attained with a lubricant distributor with the characteristics of claim 1. According to the invention, the lubricant distributor features a cavity, in which a piston is arranged in a sealed and movable fashion. This cavity consists, e.g., of a cylindrical chamber, in which a cylindrical piston is displaceably and/or rotatably accommodated. Several lubricant outlets lead into the cavity, wherein the length of the piston is chosen such that it can close all lubricant outlets relative to the cavity by closing the corresponding opening of the cavity that leads to the respective lubricant outlet. The inventive lubricant distributor furthermore features at least one lubricant inlet, from which at least one inlet channel leads into the cavity. According to the invention, a drive unit is also provided and realized in such a way that the piston can be moved in a defined fashion within the cavity. The piston itself contains at least one channel, by means of which a fluidic connection between the at least one inlet channel and one of the lubricant outlets can be produced in dependence on the position of the piston within the cavity. In other words, the piston closes the openings of the cavity that lead to the lubricant outlets, but the channel provided in the piston respectively releases one opening that leads to a lubricant outlet such that lubricant can be routed from the inlet channel to the lubricant outlet when the drive unit moves the piston into a position within the cavity in which a fluidic connection between the lubricant outlet and the channel, as well as between the channel and the inlet channel, is produced. This channel does not have to be arranged in the interior of the piston, but may also extend on the outer surface of the piston, in which case the channel is formed by the inner wall of the cavity and a region of the outer surface of the piston. In this way, it is possible to individually and variably change the quantity of lubricant delivered to the respective lubricating points during the operation of the lubricant distributor, as well as the time intervals between lubricating cycles.

Another advantage of the inventive lubricant distributor is that it can, if applicable, be used in connection with other downstream distributors such as a multiple line pump in order to realize, e.g., a zonal lubrication. In this way, different zones or regions of lubricating systems can be supplied with lubricant in an individually and variably changeable fashion.

The lubricant outlets preferably lead into the cavity at locations that are offset relative to one another in the axial direction of the cavity. Consequently, lubricant can be delivered to the respective lubricant outlet when the piston with the channel is axially moved to the corresponding lubricant outlet.

At least a few of the lubricant outlets may alternatively or additionally lead into the cavity at locations that are offset relative to one another in a direction of rotation about the longitudinal axis of the cavity. In this case, the channel of the piston can be moved into a position in which it is connected to the opening of the respective lubricant outlet to be supplied with lubricant, e.g., by rotating the piston.

According to a particularly preferred embodiment, the lubricant outlets are arranged offset relative to one another in the axial direction of the cavity, as well as in a direction of rotation about the longitudinal axis of the cavity. For example, groups of several lubricant outlets may be arranged on top of one another referred to the axial direction of the cavity, wherein the individual groups of lubricant outlets are offset relative to one another about the longitudinal axis of the cavity, e.g., by 60° or 90°. In this way, the lubricant lines branching off the lubricant outlets can be connected without mutual impairment.

According to a particularly preferred embodiment of the invention, several inlet channels lead from the lubricant inlet into the cavity at locations that are offset relative to one another in the axial direction of the cavity and/or in a direction of rotation about the longitudinal axis of the cavity. This can be realized, e.g., by producing a bore that is connected to the lubricant inlet parallel to the cavity, wherein several transverse bores lead from said bore into the cavity. In this case, the positions of the transverse bores are preferably adapted to the positions of the lubricant outlets in such a way that a fluidic connection between a transverse bore and one specific lubricant outlet can be produced via the channel of the piston while the piston closes the remaining lubricant outlets and the remaining transverse bores. Consequently, lubricant is delivered to one specific lubricant outlet in dependence on the position of the piston in the cavity.

The lubricant inlet may alternatively also lead into a groove-like depression in the wall of the cavity that forms the inlet channel. This groove-like depression is arranged in a region of the cavity that does not contain a lubricant outlet. In this way, lubricant can once again be routed from the groove-like depression into the respective lubricant outlet through the channel of the piston in dependence on the position of the piston. In this case, the remainder of the groove-like depression and the other lubricant outlets are closed by the piston.

According to another embodiment, the inlet channel may also be realized in such a way that it directly leads into the cavity, wherein the piston contains, e.g., a bore that extends parallel to the longitudinal direction of the cavity, and wherein the channel of the piston that can be connected to the respective lubricant outlet branches off said bore.

According to a particularly preferred embodiment of the invention, the channel of the piston is realized in the form of an annular groove in the outer surface of the piston. The channel therefore is defined by the base of the groove in the outer surface of the piston and the inner wall surface of the cavity. In this way, the channel can be connected to one or several lubricant outlets that lead into the cavity at locations that are offset relative to one another in the same axial position within the cavity by means of a simple axial displacement of the piston within the cavity. If the annular groove of the channel of the piston does not extend around the piston by 360°, two lubricant outlets that lead into the cavity at the same height referred to the axial direction thereof can also be supplied with lubricant or separated from the lubricant supply in a defined fashion by means of an additional rotation of the piston.

It proved particularly advantageous to realize the drive unit with a stepping motor that makes it possible to move the piston within the cavity in a defined fashion. It would alternatively also be possible to provide a geared motor that, if applicable, features a rotary encoder for the actuation of the piston. In this case, a rotational motion of a spindle or shaft is converted into an axial motion, wherein the rotary encoder serves for determining the position of the spindle or shaft. According to another embodiment of the invention, the piston may also be moved hydraulically or pneumatically, wherein the lubricant itself can also be used for the hydraulic actuation of the piston.

The objective of the present invention is furthermore attained with a lubricating system that features a lubricant distributor of the above-described type, as well as a lubricating pump that is connected to the lubricant inlet of the lubricant distributor via a line. The lubricant distributor of the lubricating system preferably is not only connected to the lubricant pump by means of the lubricant line, but also another line that supplies the drive unit for the actuation of the piston with driving energy from the lubricant pump. In this context, it proved particularly advantageous that the drive unit of the lubricant distributor is not only supplied with driving energy by the lubricant pump, but can also be actuated or controlled by means of a control unit of the lubricant pump.

In an additional development of this inventive concept, it is also possible to control several lubricant distributors, in particular, by means of a field bus system.

### BRIEF DESCRIPTION OF THE DRAWINGS

An embodiment example of the invention is described in greater detail below with reference to the figures. In this case, all described and/or graphically illustrated characteristics individually form the object of the invention regardless of the composition thereof in the claims or the references thereof to other claims.

In the schematic drawings:

FIG. 1 shows a perspective representation of an inventive lubricating system,

FIG. 2 shows a partially sectioned top view of an inventive lubricant distributor, and

FIG. 3 shows a perspective representation of the lubricant distributor according to FIG. 2.

### DETAILED DESCRIPTION

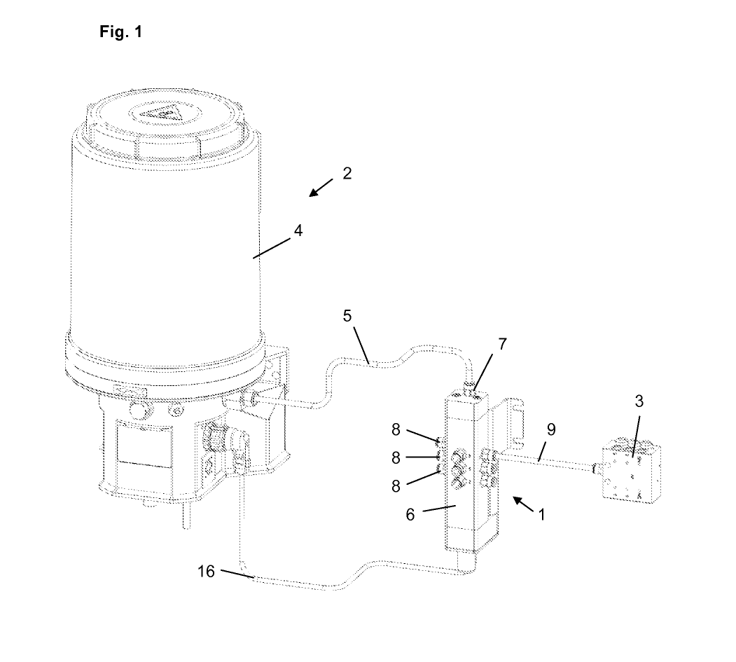

In the embodiment illustrated in FIG. 1, the lubricating system is essentially composed of a lubricant distributor 1, a lubricant pump 2 and another distributor 3, from which lubricant can be delivered to individual lubricating points (not shown). The lubricant pump 2 features a lubricant container 4, in which a supply of lubricant, particularly lubricating grease, is accommodated. A pump element that can take in lubricant from the lubricant container 4 and deliver this lubricant to the lubricant distributor 1 via a line 5 is arranged in a housing on the lower side of the lubricant container 4 in FIG. 1. The lubricant pump 2 furthermore features a control that is also arranged in a housing underneath the lubricant container 4 and makes it possible to control a driving motor for the pump element and, if applicable, an agitator blade provided in the lubricant container 4.

The lubricant distributor 1 features, e.g., an elongated base body 6 and a housing with a lubricant inlet 7 that is connected to the lubricant pump 2 via the line 5. In the embodiment shown, the lubricant distributor is provided with nine lubricant outlets 8, wherein three lubricant outlets are respectively combined into groups that lie on top of one another with reference to the longitudinal direction of the lubricant distributor 1, and wherein these groups are respectively arranged on the outer surface of the base body 6 such that they are offset relative to one another by 90°.

The lubricant outlets 8 may either be directly connected to a lubricating point via corresponding lines or connected to another distributor 3, from which lubricant outlets once again lead to the individual lubricating points, via a line 9.

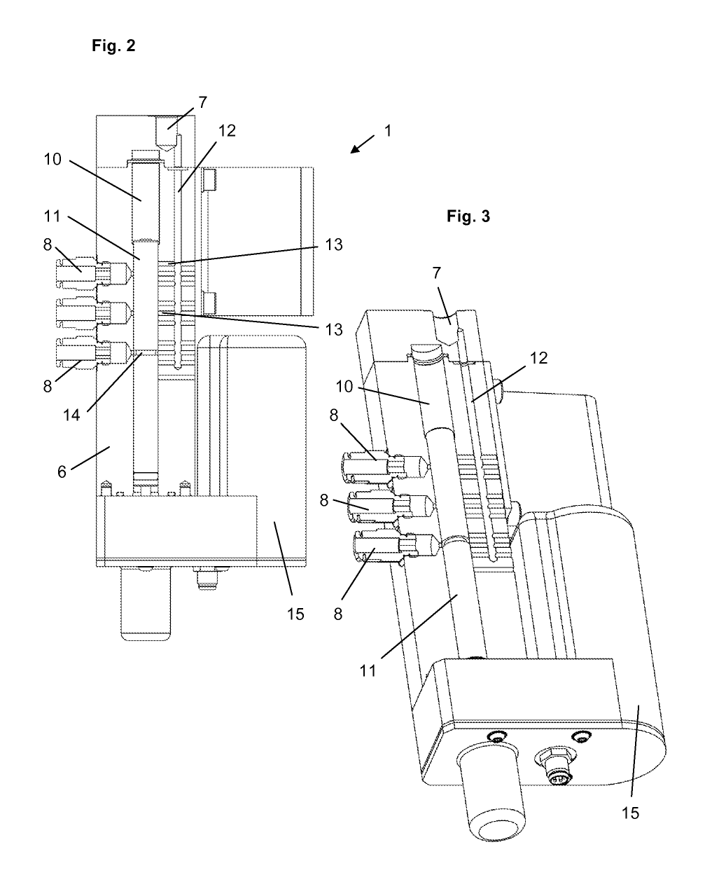

The design of the lubricant distributor 1 is illustrated in greater detail in FIGS. 2 and 3. The base body 6 contains a bore that extends in the longitudinal direction thereof and defines a cylindrical cavity 10. On its upper side in the figures, the base body 6 or the cavity 10 may be closed with a cover, wherein the lubricant inlet 7 leads into said cover.

A cylindrical piston 11 is arranged in the cavity 10 and guided in a sealed fashion within the cavity 10. According to FIG. 2, the lubricant outlets 8 lead into the cavity 10 at locations that are axially offset relative to one another in the longitudinal direction of the base body 6 and in the longitudinal direction of the cavity 10, respectively. FIG. 1 shows nine lubricant outlets 8, wherein each lubricant outlet 8 is axially offset relative to the other lubricant outlets such that openings of the lubricant outlets 8 leading into the cavity 10 do not overlap in the axial direction. In other words, the three respective groups of lubricant outlets are not only arranged in the lubricant distributor 1 such that they are offset relative to one another by 90°, but also slightly offset relative to the other groups of lubricant outlets in the axial direction.

In the embodiment shown, another bore 12 extends in the base body 6 parallel to the bore of the cavity 10, wherein this bore 12 is connected to a lubricant inlet 7 and forms an inlet channel. Several transverse bores 13 extend through the base body from the bore 12 in such a way that the transverse bores 13 connect the bore 12 to the cavity 10 at locations that are axially offset relative to one another. In this case, the positions of the transverse bores 13 are adapted to the positions of the lubricant outlets 8 in such a way that each transverse bore and one specific opening of a lubricant outlet 8 respectively lie at the same height with reference to the axial direction of the cavity 10. Consequently, each transverse bore 13 is assigned to one specific lubricant outlet 8 in a defined fashion.

In order to transport the lubricant from the inlet channel and the transverse bores 13 into one respective lubricant outlet 8, an annular peripheral groove 14 is arranged on the piston 11 and forms a (additional) channel 14 together with the inner wall surface of the cavity 10, wherein this additional channel respectively connects a transverse bore 13 to a specific lubricant outlet 8 in dependence on the position of the piston 11 within the cavity 10. In this case, the lubricant initially flows out of the transverse bore 13 and around the piston 11 through the channel 14 and then into the opening within the cavity 10 that belongs to the respective lubricant outlet 8. Consequently, lubricant can be delivered from the lubricant inlet 7 to one of the lubricant outlets 8 in a defined fashion in dependence on the position of the piston 11 within the cavity 10.

In order to move the piston 11 within the cavity 10, a drive unit 15 such as, e.g., a stepping motor is assigned to the piston 11 in such a way that the piston 11 can be moved in the axial direction of the cavity 10 in a defined fashion by the drive unit 15. For this purpose, the drive unit 15 is connected to the lubricant pump 2 or its control via a cable 16 such that the lubricant distributor 1 can also be controlled and supplied with energy in a defined fashion by the control of the lubricant pump 2.

Instead of supplying the drive 15 via the cable 16, the pressure generated by the lubricant pump in a hydraulic drive of the piston 11 can also be used for the control and/or actuation of the piston.

The inventive design of the distributor 1 makes it possible to open and connect each of the lubricant outlets 8 to a lubricant inlet 7, wherein the opening time and the sequence in which the lubricant outlets 8 are opened can be individually defined. Consequently, the remaining lubricant outlets can also be supplied with lubricant if the line or lubricating point connected to one of the lubricant outlets 8 is blocked, i.e., clogged or the like.

List of Reference Symbols:
1 Lubricant distributor
2 Lubricant pump
3 Additional distributor
4 Lubricant container
5 Line
6 Base body
7 Lubricant inlet
8 Lubricant outlet
9 Line
10 Cavity
11 Piston
12 Inlet channel
13 Transverse bore
14 Additional channel (groove)
15 Drive unit
16 Cable

1. A lubricant distributor for distributing lubricant to several lubricating points, comprising
a cavity, in which a piston is arranged in a sealed and movable fashion, wherein several lubricant outlets that are sealed relative to the cavity by the piston lead into said cavity,
a lubricant inlet, from which at least one inlet channel leads into the cavity, and
a drive unit for moving the piston in the cavity in a defined fashion,
wherein at least one channel is formed in the piston and makes it possible to produce a fluidic connection between the at least one inlet channel and one of the lubricant outlets in dependence on the position of the piston within the cavity.

2. The lubricant distributor according to claim 1, characterized by the fact that the lubricant outlets lead into the cavity at locations that are offset relative to one another in an axial direction of the cavity.

3. The lubricant distributor according to claim 1, characterized by the fact that at least a few of the lubricant outlets lead into the cavity at locations that are offset relative to one another in a direction of rotation about a the longitudinal axis of the cavity.

4. The lubricant distributor according to claim 1, characterized by the fact that several inlet channels lead from the lubricant inlet into the cavity at locations that are offset relative to one another in an axial direction of the cavity and/or offset relative to one another in a direction of rotation about a longitudinal axis of the cavity.

5. The lubricant distributor according to claim 1, characterized by the fact that the lubricant inlet leads into a groove-like depression in the wall of the cavity that forms the inlet channel.

6. The lubricant distributor according to claim 1, characterized by the fact that the lubricant inlet leads into an inlet channel formed in the piston.

7. The lubricant distributor according to claim 6, characterized by the fact that the channel is realized in the form of an annular groove in the outer surface of the piston.

8. The lubricant distributor according to claim 1, characterized by the fact that the drive unit features a stepping motor or a geared motor that converts a rotary motion into a translatory motion.

9. A lubricating system comprising a lubricant distributor according to claim 1 and a lubricant pump that is connected to the lubricant inlet via a line.

10. The lubricating system according to claim 9, characterized by the fact that the drive unit of the lubricant distributor is supplied with driving energy by the lubricant pump and/or can be actuated by means of a control unit of the lubricating pump.

11. The lubricating system according to claim 9, comprising several lubricant distributors that can be controlled by means of a field bus system.

12. The lubricant distributor according to claim 1, characterized by the fact that the lubricant outlets lead into the cavity at locations that are offset relative to one another in an axial direction of the cavity, and characterized by the fact that several inlet channels lead from the lubricant inlet into the cavity at locations that are offset relative to one another in the axial direction of the cavity and/or offset relative to one another in a direction of rotation about a longitudinal axis of the cavity.

13. The lubricant distributor according to claim 1, characterized by the fact that at least a few of the lubricant outlets lead into the cavity at locations that are offset relative to one another in a direction of rotation about a longitudinal axis of the cavity, and characterized by the fact that several inlet channels lead from the lubricant inlet into the cavity at locations that are offset relative to one another in an axial direction of the cavity and/or offset relative to one another in a direction of rotation about the longitudinal axis of the cavity.
